(19) United States
(12) Patent Application Publication
(10) Pub. No.: US 2009/0204678 A1
(43) Pub. Date: Aug. 13, 2009

(54) System and method for enabling collaboration among invitees

(75) Inventor: Bharat Punjalal Shah, Delhi (IN)

Correspondence Address: HAMILTON, BROOK, SMITH & REYNOLDS, 530 VIRGINIA ROAD, PO BOX 9133, CONCORD, MA, 01742-9133, US

(73) Assignee: International Business Machines Corporation, Armonk, NY (US)

(21) Appl. No.: 12/060,107

(22) Filed: Mar. 31, 2008

Related U.S. Application Data
(63) Continuation of application No. 12/027,708, filed on Feb. 7, 2008.

(51) Int. Cl. G06F 15/16

(52) U.S. Cl. 709/206

(57) ABSTRACT

A method and system to enable dialogue and collaboration among event participants for an event request. Event participants collaborate within the context of the event request, for example a meeting request. The participants are allowed to send their responses on a event request to other participants and not limit or restrict the responses to the event organizer.

### RELATED APPLICATION

Previously filed patent application entitled “Method and system to enable in-context pre-meeting dialogue and collaboration among invitees” filed on Feb. 7, 2008 and application Ser. No. 12/027,708, is hereby in its entirety incorporated by reference.

### BACKGROUND OF THE INVENTION

The present invention is related to field of collaborative computing, and more particularly to event management tools in a collaborative computing environment.

Currently event management tools, for example a calendaring system, while processing event requests, such as a meeting request, allows an invitee assigned to the event to respond only to the organizer (chair). The invitees response, whether “accept”, “decline”, “delegate other” and so on, with or without comments is sent only to the event organizer.

Without a method to enable effective and efficient collaboration between all participants/invitees for an event request the promise of this technology may never be fully achieved.

### SUMMARY OF THE INVENTION

Disclosed is a method and system to enable dialogue and collaboration among event participants for an event request. Event participants collaborate within the context of the event request, for example a meeting request. The participants are allowed to send their responses on an event request to other participants and not limit or restrict the responses to the event organizer.

Accordingly the invention relates to event management/organizing tools that allow invitees to deliberate/collaborate within a context of an event, for example an event invite. The invitees should be allowed to send their responses on the event to other invitees and not limit/restrict the responses to the event organizer (chair) only. In a further embodiment, the invitee responding to the event invite may choose from the list of invitees (also referred to as participants in this application) who may receive the response. In a further embodiment, the event organizer (chair) may allow only certain invitees to send and receive responses from other invitees.

An advantage is that invitees to an event are allowed to collaborate among themselves and with the chair person organizing the event regarding various details of the event. For example, these could include a proposed agenda for a scheduled meeting. A further advantage is that some invitee(s) can select invitees form the list of invitees to be notified about their response i.e. acceptance/decline, especially in situations when some invitees may want to decide about participating in the event depending on whether some other invitees will attend. Yet a further advantage is that members of a sub-team can ensure that someone from the sub-team attend the event. Essentially this feature enables “In Context” pre event planning, dialogue and deliberations among event participants, consequently leading to effective participation by the invitees.

### BRIEF DESCRIPTION OF THE DRAWINGS

FIG. 1 is a schematic diagram of the calendar products, while processing meeting requests.

FIG. 2 is a schematic diagram of the pre-meeting dialogue and collaboration among invitees.

FIG. 3 is a general purpose computer system on which the event management/organizing tools may be implemented.

### DETAILED DESCRIPTION OF THE PREFERRED EMBODIMENTS

Processing a response to an event, for example a meeting invite, needs to be extended so that the response from the invitees can be sent to not only the event organizer but to other invitees/selected invitees from among all the invitees. Such processing could ensure that such exchange of responses among the invitees and the event organizer occurs within the context (“In Context”) of the event. In one embodiment, the event organizer may be allowed to identify some invitees (hereinafter also referred to as participants) and set rules for the communication of responses between such invitees. For example, rules such that only a certain number of invitees may deliberate amongst each other regarding a fixed topic/task in an agenda, where the agenda consists of a number of topics/task. This is typically realized by adding steps to the event management/organizing tool.

The organizer of an event is typically allowed to select a number of invitees to an event and then sends (transmits) the invite to the invitees by means such as electronic mail or the likes. The invitees are recipients of the event invite and can respond to the event organizer regarding their decision, which may or may not include comments. The invitee at the time of submitting his/her response (with or without comments) to the event request, is offered a list of all invitees to select those invitees to whom s/he wants the response sent. By default, the event organizer (chair) should receive all responses. The response is then sent not only to the event organizer but also to all the selected invitees. The receiving invitees receive responses such as any event updates with the facility to respond to them in the same manner as with the event originating message, for example such as a meeting invite. The receiving invitees can respond to such responses as have been described previously. In all cases, subsequent responses will always go to the event organizer. S/he will also have the same facility to respond as other invitees as has been described previously.

Exchanging a series of responses among the invitees and the event organizer “In Context” of the event invite will facilitate multi-party interaction and collaboration and help all invitees to accomplish all pre-meeting deliberations. Advantageously, the invention may be practiced in a variety of fields including: Collaboration and Applications Contextual Collaboration and/or Contextual Collaboration thru its implementation in an electronic calendar product.

The participants are provided a variety of options to reply to the event request such as accepting the event request, declining the event request, delegating the event request to another participant or user, requesting re-scheduling of the event at a different time and such a reply may further include a comment. In one embodiment, the comment may be null. Further, the event participants may reply and follow-up on replies thereby creating a chain of events with respect to an event request. In a further embodiment these replies and follow-ups (follow-up replies in response to replies that have already been made) may be categorized into predetermined categories by the event organizer thereby advantageously increasing the viewing efficiency of the event participants. Categorizing allows participants to view replies and follow-ups in a particular category that may interest only a certain group of participants. It should be obvious to one skilled in the art that the categories may be further sub-divided to a limit desired and decided by the event organizer and such features fall within the scope of the present invention. In a further embodiment, the event organizer may provide access control to selected invitees to some of the selected categories, and such privileged information will not be available to all the event participants. It should be obvious to one skilled in the art that access control may also be provided to participants based on the categories created by the event organizer. Such access control may be decided by the event organizer.

For example, the comment may include a suggestion about agenda items or conditions for attending/participating in the event or suggestions of other participants or inclusion/exclusion of other participants and other tasks. In a further embodiment, the event organizer may set rules regarding the replies and follow-up replies received from the participants for viewing, and may further provide a privileged set of participants to create and access information that may not be visible to all participants. In one embodiment, the replies may be categorized into tasks, goals, interests and other relevant topics as decided by the event organizer.

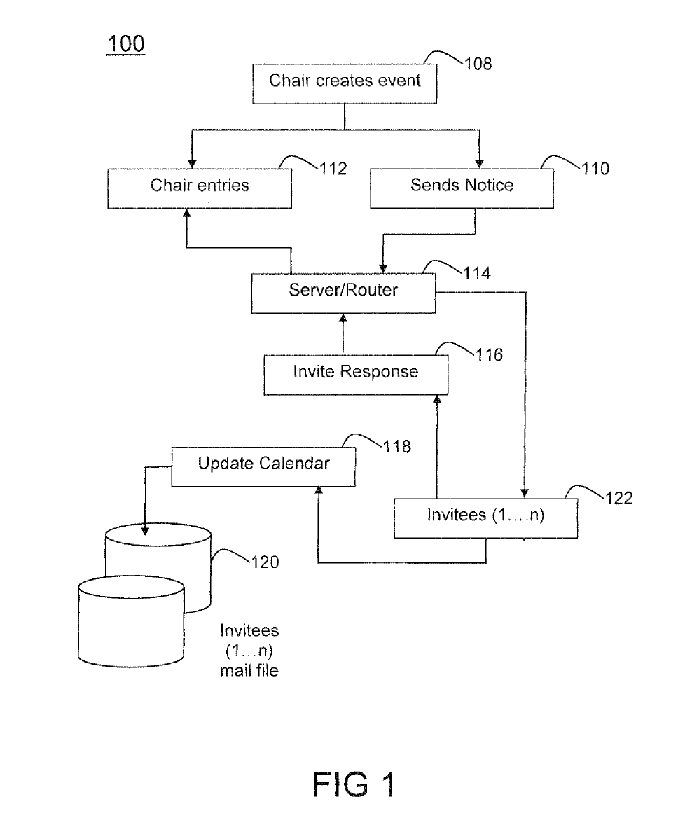

Reference is now made to FIG. 1 which illustrates a method (100) of processing an event request in an event management/organizing tool. For example this includes calendar tools for processing a meeting request. In one embodiment for a given operation the event organizer (chair) creates event request (108), such as a meeting request, and sends the event invitation to selected set of invitees. The event management/organizing tool, for example the calendar, creates a document in organizer's events record and transmits a notice (110) document to each invitee, preferably by electronic mail. It should be obvious to one skilled in the art that other forms of transmittal which include an electronic means fall within the scope of this invention. For example short messaging service can include one form of transmittal.

The invitee (recipient of the event invite also referred to as participants or event participants) has a choice of accepting or declining (116) the invite, for example a event request, which could be a meeting request. For simplicity only two options of accepting or declining are shown in the Figure, and it should be obvious to one skilled in the art that various other options may also be available to the invitee, such as delegating the event (event invite) to another user, rescheduling the event and so on, and all such options fall within the scope of the present invention. All responses from the invitees are preferably communicated back to the chair (112), for example by means of an email, and updates in the invitee calendar (118). It should be apparent that various other options such as a SMS, chat, phone call etc., can be used to communicate with the chair (112) and the various means of communication with the chair (112) fall within the scope of the present invention.

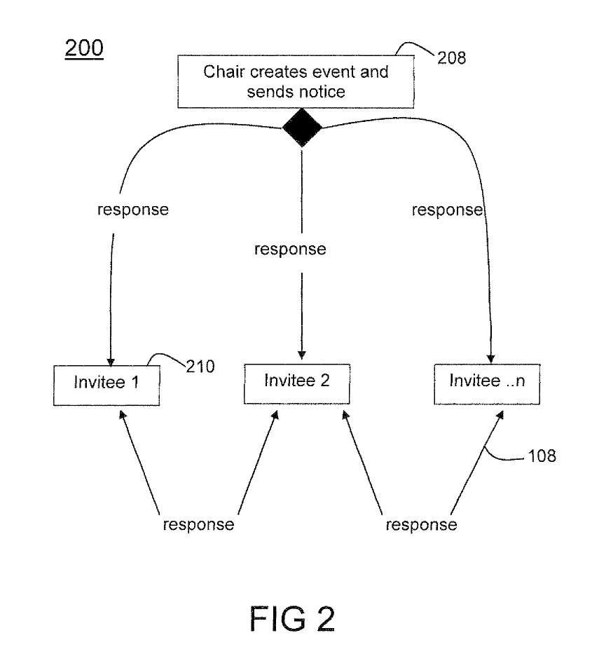

FIG. 2 is a schematic diagram of a method (200) of the pre-event dialogue and collaboration among invitees. In one embodiment for a given operation the event organizer (chair) creates an event request (208) and sends/transmits the request (invitation) to a list of selected invitees. The response to this invitation sent to a list of selected invitees from any one of the selected invitees is sent not only to the event organizer but also to all other invitees selected by him/her (212). This can include a new list of participants as well. The receiving invitees receive such responses as event updates with the facility to respond to them in the same manner as the event invite. In one embodiment, when multiple responses are received, the responses may be categorized in ascending or descending chronological order or any other pre-determined order chosen by the invitee. In a further embodiment, when one invitee is responding with comments, to avoid repeated confusion that may be created because of multiple responses, the response mechanism for other invitees can be temporarily locked when one of the invitees is responding to the original event request that has been received.

Processing an event invite, for example a meeting request considering a calendar system, for more than one invitee, involves individual invitees to check if s/he can send a response to the event invite, not only to the event organizer but also to other invitees. Receiving invitees can then check if they receive such response from the other invitees and whether or not they can respond to it further. In one embodiment such rules if any may be defined by the organizing chair. In a further embodiment if any of the invitees does not wish to receive further responses from the other invitees, the invitee may set the rule such that in no further deliberations that will occur the invitee/participant who opted out of the deliberations will be intimated in any of the replies or follow-ups. In a further embodiment, the organizer (chair) may be provided with an option to block recipients from sending further communication and provide a event directive, without an option for other selected invitees to respond.

In a preferred embodiment, the event organizing products can be considered to be a calendaring tool that allows invitees to deliberate/collaborate within the context of a meeting invite. Invitees should be allowed to send their responses on a meeting invite to other invitees and not limit/restrict the responses only to the meeting/event organizer (chair). In a further embodiment, invitees of a meeting should be able to select the invitees (some or all invitees) who can receive his/her response to the meeting invite, in addition to that of the meeting chair. In yet a further embodiment, the invitees should be able to respond to such (received) responses in the same manner as the meeting invite. For every response, the recipient should be able to send his/her response to all or selected subset of the recipients of that response, i.e., every response is processed in the same manner as a meeting invite, and the additional contents/comments generated as added to the calendar, thereby keeping track of the discussion trail. The additional contents/comments may be stored in a structure or unstructured format.

In a further embodiment, the invitees to a meeting should be able to collaborate within the context of the meeting by using the responses to the invite/responses for sharing comments and their acceptance/decline for the meeting with the other selected invitees (a subset chosen by the invitee(s)). All such responses being consolidated in the meeting invite of individual invitees. In yet a further embodiment, a selected invitee may delegate another invitee on his behalf and the delegated invitee will replace the selected invitee on the list of selected invitees. All collaboration/deliberations will now occur with the delegated invitee instead of the originally selected invitee.

In one embodiment a method of enabling in-context pre-meeting dialogue and collaboration among meeting invitees is disclosed. A first entity invites two or more invitees to a meeting. Next, a first group is formed by grouping the first entity with the two or more invitees. Next, the first group is divided into multiple sub-teams, based on different tasks, goals, or interests. Next, a first invitee among the two or more invitees selectively responds to one or more of the members of the first group, about intention of the first invitee among the two or more invitees to attend the meeting.

Subsequently, the first invitee among the two or more invitees selectively sends comments to one or more of the members of the first group. Next, the first invitee among the two or more invitees selectively performs in-context pre-meeting planning with one or more of the members of the first group. Next, the first invitee among the two or more invitees selectively collaborates with one or more of the members of the first group about an agenda of the meeting. Next, the first invitee among the two or more invitees selectively sets a condition to attend the meeting based on attendance of one or more of the members of one or more of the multiple sub-teams.

Subsequently, the first invitee among the two or more invitees selectively sets a condition to act on the agenda of the meeting based on actions of one or more of the members of one or more of the multiple sub-teams. Next, the first invitee among the two or more invitees selectively reviews the comments exchanged between one or more of the members of one or more of the multiple sub-teams. Finally, meeting updates are coordinated with a calendar database.

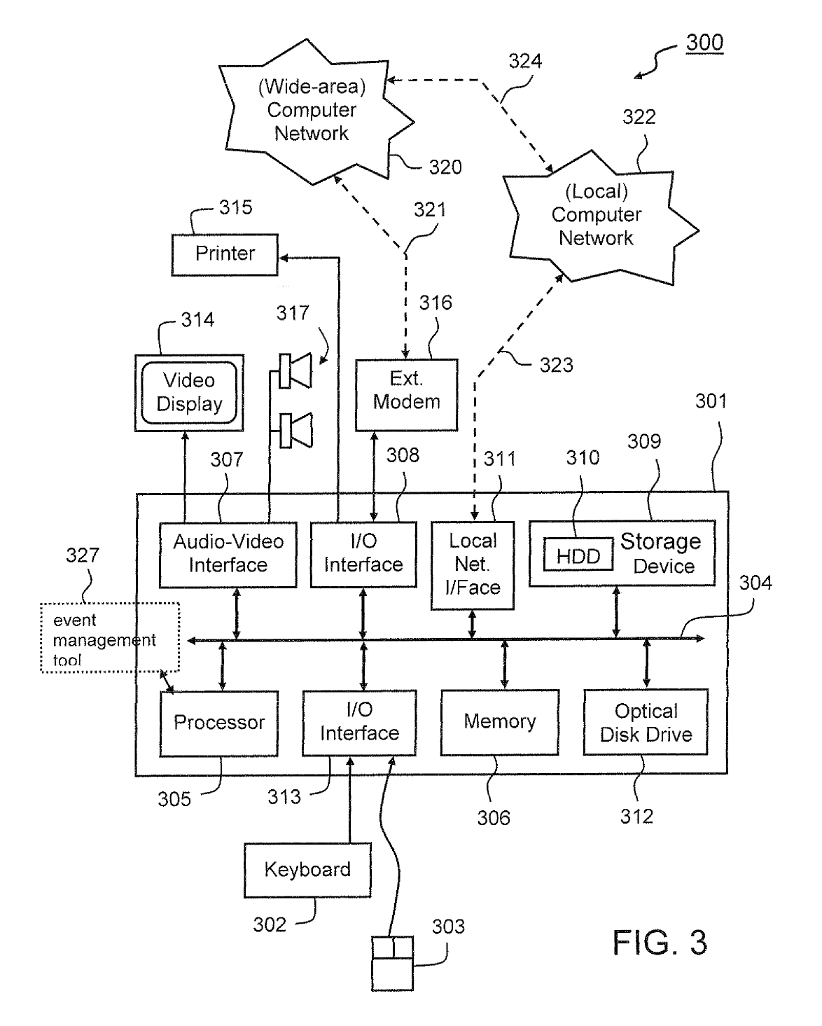

Embodiments of the invention described herein with reference to FIGS. 1 and 2 may be implemented using a electronic device 300, hereinafter also generically referred to as a computer system 300, such as that shown in FIG. 3. The electronic device includes and is not limited to a desktop computer, a laptop computer, a pocket personal computer, a personal digital assistant, a mobile phone and so on. It should be apparent to one skilled in the art that the electronic device covers a variety of products that has at least a processor and a memory running an operating system and capable of executing an event organizing/management tool. The event management tool may be stored on the electronic device or on a storage medium external to the electronic device to which the electronic device may be coupled using a wired network or a wireless network or a combination thereof. In a further embodiment, the event management tool may be stored in embedded form on the electronic device.

The processes of FIGS. 1 and 2 may be implemented as software executable within the computer system 300. In particular, steps of the methods shown in FIGS. 1 and 2 are effected by instructions in the software, for example such as a event organizing/management software application, that are carried out within the computer system 300. The instructions may be formed as one or more code modules, each for performing one or more particular tasks. The software may also be divided into two separate parts, in which a first part and the corresponding code modules performs the methods for uninterrupted execution of an application program and a second part and the corresponding code modules manage a user interface between the first part and the user. The software may be stored in a computer readable medium, including the storage devices described hereinafter. The software is loaded into the computer system 300 from the computer readable medium and executed by the computer system 300. A computer readable medium having such software or computer program recorded on the computer readable medium is a computer program product. The use of the computer program product in the computer system 300 preferably effects an advantageous system for uninterrupted execution of an application program.

As shown in FIG. 3, the electronic device 300, hereinafter also referred generically to as a computer system, is formed by a computer module 301, input devices such as a keyboard 302 and a mouse pointer device 303, and output devices including a printer 315, a display device 314 and loudspeakers 317. An external Modulator-Demodulator (Modem) transceiver device 316 may be used by the computer module 301 for communicating to and from a communications network 320 via a connection 321. The network 320 may be a wide-area network (WAN), such as the Internet or a private WAN. Where the connection 321 is a telephone line, the modem 316 may be a traditional “dial-up” modem. Alternatively, where the connection 321 is a high capacity connection, the modem 316 may be a broadband modem. A wireless modem may also be used for wireless connection to the network 320.

The computer module 301 typically includes at least one processor unit 305, and a memory unit 306 for example formed from semiconductor random access memory (RAM) and read only memory (ROM). The module 301 also includes a number of input/output (I/O) interfaces including an audio-video interface 307 that couples to the video display 314 and loudspeakers 317, an I/O interface 313 for the keyboard 302 and mouse 303 and optionally a joystick (not illustrated), and an interface 308 for the external modem 316 and printer 315. In some implementations, the modem 316 may be incorporated within the computer module 301, for example within the interface 308. The computer module 301 also has a local network interface 311 which, via a connection 323, permits coupling of the computer system 300 to a local computer network 322, known as a Local Area Network (LAN). As also illustrated, the local network 322 may also couple to the wide network 320 via a connection 324, which would typically include a so-called “firewall” device or similar functionality. The interface 311 may be formed by an Ethernet™ circuit card, a wireless Bluetooth™ or an IEEE 802.11 wireless arrangement.

The interfaces 308 and 313 may afford both serial and parallel connectivity, the former typically being implemented according to the Universal Serial Bus (USB) standards and having corresponding USB connectors (not illustrated). USB and Firewire are common interfaces used for connection to such a scanner as are other serial and parallel interfaces. Storage devices 309 are provided and typically include a hard disk drive (HDD) 310. Other devices such as a memory stick, a floppy disk drive and a magnetic tape drive (not illustrated) may also be used. An optical disk drive 312 is typically provided to act as a non-volatile source of data. Portable memory devices, such optical disks (e.g., CD-ROM, DVD), USB-RAM, and floppy disks for example may then be used as appropriate sources of data to the system 300.

The components 305 to 313 of the computer module 301 typically communicate via an interconnected bus 304 and in a manner which results in a conventional mode of operation of the computer system 300 known to those in the relevant art. Examples of computers on which the described arrangements can be practised include IBM-PC's and compatibles, Sun Sparcstations, Apple Mac™ or like computer systems evolved therefrom.

The computer system 300 consists of an event organization/management tool 327 which is loaded onto the memory and executable on the processor 305 and is configured perform the method as disclosed previously with respect to FIGS. 1 and 2. The event organization/management tool which is a typically a software application may be implemented as a software application or may be embedded into hardware elements.

Typically, the software is resident on the hard disk drive 310 and read and controlled in execution by the processor 305. Intermediate storage of such programs and any data fetched from the networks 320 and 322 may be accomplished using the semiconductor memory 306, possibly in concert with the hard disk drive 310. In some instances, the software may be supplied to the user encoded on one or more CD-ROM and read via the corresponding drive 312, or alternatively may be read by the user from the networks 320 or 322. Still further, the software can also be loaded into the computer system 300 from other computer readable media. Computer readable media refers to any storage medium that participates in providing instructions and/or data to the computer system 300 for execution and/or processing. Examples of such media include floppy disks, magnetic tape, CD-ROM, a hard disk drive, a ROM or integrated circuit, a magneto-optical disk, or a computer readable card such as a PCMCIA card and the like, whether or not such devices are internal or external of the computer module 301. Examples of computer readable transmission media that may also participate in the provision of instructions and/or data include radio or infra-red transmission channels as well as a network connection to another computer or networked device, and the Internet or Intranets including e-mail transmissions and information recorded on Websites and the like. The second part of the application programs and the corresponding code modules mentioned hereinbefore may be executed to implement one or more graphical user interfaces (GUIs) to be rendered or otherwise represented upon the display 314. Through manipulation of the keyboard 302 and the mouse 303, a user of the computer system 300 and the application may manipulate the interface to provide controlling commands and/or input to the applications associated with the GUI(s).

Any variations of the above teaching are also intended to be covered by this patent application.

1. A computer implemented method for enabling collaboration among event participants, the method comprising:
a. using a computer system executing an application tool, creating an event request to an event by an event organizer;
b. transmitting the event request created to a plurality of participants, wherein the plurality of participants include at least two or more participants selected by the event organizer;
c. through the computer system executing the application tool, the event organizer receiving a reply from a participant in the plurality of participants in response to the transmitted event request and in context of the event request, wherein each participant in the plurality of participants receiving the event request is further configured to receive in context replies to the event request made by other participants in the plurality of participants receiving the event request;
d. recording in the computer system the replies with respect to the event request by repeating step (c) for each different participant in the plurality of participants thereby enabling collaboration amongst the participants.

2. The method of claim 1, wherein the reply to the event request comprises a comment and at least one of
a. accepting participation in the event;
b. declining participation in the event
c. delegating participation in the event to a selected user; and
d. requesting a reschedule of the event at a different time.

3. The method of claim 1, wherein each participant can respond to received responses in the same manner as replying to the event request.

4. The method of claim 2, wherein one of the participants from the plurality of participants selects participants to whom the reply is transmitted in addition to the event organizer.

5. The method of claim 1, wherein the event organizer categorizes replies and follow-up replies in a manner increasing viewing efficiency; and
selected participants may be provided privileged access by the event organizer to some categories of replies and follow-up replies in addition to replies and follow-up replies made by all other participants.

6. The method of claim 1, wherein the event request comprises at least one of a meeting request or a calendar request.

7. A computer method for collaborating among event participants, the method comprising:
using a computer system:
a. receiving a event request to an event from a event organizer by a plurality of participants;
b. through a computer application tool, each participant in the plurality of participants replying to the event request in an in context manner, wherein each reply includes a respective comment and at least one of
i. accepting participation in the event;
ii. declining participation in the event
iii. delegating participation in the event to a selected user; and
iv. requesting a reschedule of the event at a different time;
c. for each participant, transmitting the reply from the participant to the event organizer and all other participants, wherein the participants are selected by the event organizer, said transmitting of replies enabling collaboration amongst the participants.

8. The method of claim 7, wherein participants are allowed to include a follow-up reply to a reply already made by a first participant, wherein all replies and follow-up replies are transmitted to the event organizer and to participants selected by the event organizer.

9. The method of claim 8, wherein the event organizer may set rules regarding the replies made by participants, and wherein the rules provide access control for creating and accessing replies and follow-up replies to the event request for the participants.

10. The method of claim 9, wherein the replies and follow-up replies are classified into predetermined categories by the event organizer.

11. The method of claim 8, wherein the event organizer is configured to add new participants, wherein each new participant added to the event after the event request was first transmitted is configured to view the replies and follow-up replies exchanged between the participants and limited to the replies and follow-up replies viewed by all participants and not the replies and follow-up replies addressed to selected participants.

12. A network based system for enabling collaboration between event participants comprising;
a first device belonging to an event organizer and at least two or more devices belonging to event participants, the devices comprising at least a memory and a processor, and coupled over a network;
an event management software executable on the processor of the devices, wherein the event management software allows an event organizer to create and transmit an event request to an event to a plurality of event participants selected by the event organizer; the event management software further configured to receive and record in-context replies from the event participants to the event request wherein the event organizer and the event participants are allowed to view in context of the event request the replies thereby enabling collaboration amongst the event participants.

13. The network based system of claim 12, wherein the reply to the event request comprises at least one of
a. accepting participation in the event;
b. declining participation in the event
c. delegating participation in the event to a selected user; and
d. requesting a reschedule of the event at a different time, wherein the reply further comprises at least a comment.

14. The network based system of claim 13, wherein one of the event participants from the plurality of event participants selects event participants to whom the reply is transmitted in addition to the event organizer.

15. The network based system of claim 12, wherein selected event participants may be provided privileged access by the event organizer to certain categories of replies and follow-up replies, as categorized by the event organizer, in addition to replies and follow-up replies made by all other event participants.

16. The network based system of claim 12, wherein the devices belonging to event participants are configured to:
a. receive the event request from the event organizer;
b. reply to the event request in-context of the even request, wherein the reply includes at least one of
i. accepting participation in the event;
ii. declining participation in the event
iii. delegating participation in the event to a selected user; and
iv. requesting a reschedule of the event at a different time, and at least a comment; and
c. transmit the reply from a respective event participant to the event organizer and all other event participants.

17. The network based system of claim 16, wherein event participants are allowed to include a follow-up reply to a reply already made by a first event participant, wherein all replies and follow-up replies are transmitted to the event organizer and the event participants selected by the event organizer.

18. The network based system of claim 17, wherein the event organizer may set rules regarding the replies made by event participants, and wherein the rules provide access control to create and access certain categories of the replies and follow-up replies for the event request.

19. The network based system of claim 17, wherein the replies and follow-up replies are classified into predetermined categories by the event organizer.

20. The network based system of claim 17, wherein the event organizer is configured to add new participants, wherein each new participant added to the event after the event request was first transmitted is configured to view the replies and follow-up replies exchanged between the new participants and limited to the replies and follow-up replies viewed by all participants and not the replies and follow-up replies addressed to selected participants.

21. The network based system of claim 17, wherein the event management software is stored on a readable medium external to the devices.
